(19) United States
(12) Patent Application Publication
(10) Pub. No.: US 2010/0198950 A1
(43) Pub. Date: Aug. 5, 2010

(54) Method to deliver services over existing wireless lan infrastructure

(75) Inventors: D. Karthikeyan Balaji, Chennai (IN); Seema Chinmay Albal, Bangalore (IN); Puneet Gupta, Bangalore (IN)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Infosys Technologies Limited, Bangalore (IN)

(21) Appl. No.: 12/386,671

(22) Filed: Apr. 21, 2009

(30) Foreign Application Priority Data
Apr. 21, 2008 (IN) 966/CHE/2008

(51) Int. Cl. G06F 15/16; G06F 15/177

(52) U.S. Cl. 709/222; 709/230; 709/238

(57) ABSTRACT

A method to bypass the existing pay and use model to deliver services over existing wireless LAN infrastructure between mobile terminal and server is disclosed. Many of the existing WLAN infrastructures require users to subscribe to service provider to access their network. The inventive method uses internet protocol (IP) packet for delivering services/data between server and mobile terminal. Internet protocol (IP) layer processes the IP packets received from a mobile terminal and uses protocol subfield in the IP header of the received IP packet in identifying the services/data at the server end. The server sends the IP packet containing requested services/data to the mobile terminal. Since all the communication takes place at IP layer (not TCP or UDP) it doesn't require user id and password to go through.

### BACKGROUND OF THE INVENTION

The invention relates generally to communications networks and more particularly to delivering services over existing wireless local area networks (WLAN) infrastructure via an access point (AP).

Many of the existing WLAN infrastructures require users to subscribe to service provider to access their network. There are situations in which user requires only limited access to the network, such as requesting critical network information or location based information for which subscription based model is not economically viable.

In order to access information over WLAN networks, a user with an end device must follow a three step process to get connected: a) discover the network b) associate with the network c) authenticate with the network.

Authentication with the network usually requires the user to provide some credentials (unless in case of open authentication), which may be provided for a fee. Also, to connect to various WLAN networks at different geographies, different credentials may be required.

Hence the steps involved to access information are many and has to be repeated to connect to different WLAN networks.

And moreover, delivery of internet services over existing WLAN infrastructure is seriously limited because of the pay and use model adopted by most of the service providers.

Secondly, the need for different subscriptions for users to connect to different WLAN hotspots further limits the number of users to connect to WLAN networks to access information.

This invention addresses the problem of delivery of innovative services hosted in the internet using existing WLAN infrastructure without user having to subscribe to the network service provider.

### BRIEF SUMMARY OF THE INVENTION

In one embodiment of the present technique, a method to bypass the existing pay and use model to deliver services over existing wireless LAN infrastructure between mobile terminal and server is disclosed. Many of the existing WLAN infrastructures require users to subscribe to service provider to access their network. There are situations in which user requires only limited access to the network, such as requesting critical network information or location based information for which subscription based model is not economically viable. This method addresses such needs by using packets which are allowed to pass through the wireless network without subscribing to the network access service. This immensely helps user by not having to subscribe to the multiple service providers to access useful services hosted in the internet.

The proposed method uses internet protocol (IP) packet for delivering services/data between server and mobile terminal. Internet protocol (IP) layer processes the IP packets received from a mobile terminal and uses protocol subfield in the IP header of the received IP packet in identifying the services/data at the server end. The server sends the IP packet containing requested services/data to the mobile terminal. This invention addresses the problem of delivery of innovative services hosted in the internet using existing WLAN infrastructure without user having to subscribe to the network service provider.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of hardware and software components in one embodiment of the present technique;

FIG. 2 is a format of the IP Packet and format of the IP Header, in one embodiment of the present technique; and

FIG. 3 is a system illustrating a generalized computer network arrangement, in one embodiment of the present technique

### DETAILED DESCRIPTION

The following description is full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of the user. Further, some of the features of the present technique may be used to advantage without the corresponding use of other features described in the following paragraphs. As such, the present description should be considered as merely illustrative of the principles of the present technique and not in limitation thereof, since the present technique is defined solely by the claims.

As a preliminary matter, the definition of the term “or” for the purpose of the following discussion and the appended claims is intended to be an inclusive “or” That is, the term “or” is not intended to differentiate between two mutually exclusive alternatives. Rather, the term “or” when employed as a conjunction between two elements is defined as including one element by itself, the other element itself, and combinations and permutations of the elements. For example, a discussion or recitation employing the terminology “A” or “B” includes: “A” by itself, “B” by itself and any combination thereof, such as “AB” and/or “BA.” It is worth noting that the present discussion relates to exemplary embodiments, and the appended claims should not be limited to the embodiments discussed herein.

The present invention relates to generally to communications networks and more particularly to delivering services over existing wireless LAN infrastructure via an access point.

Many of the existing WLAN infrastructures require users to subscribe to service provider to access their network. There are situations in which user requires only limited access to the network, such as requesting critical network information or location based information for which subscription based model is not economically viable. This method addresses such needs by using packets which are allowed to pass through the wireless network without subscribing to the network access service. This immensely helps user by not having to subscribe to the multiple service providers to access useful services hosted in the internet. One of the novel applications of this method is delivering advertisement information using existing WLAN infrastructure.

Subscription based WLAN infrastructure prompts the user to enter user id and password when any attempt to access internet is made but allows the user to establish connection at layer 2 level in open model. The invention overcomes the existing limitation by communicating at lower layer (IP layer) instead of using higher layer protocols like TCP and UDP. At the IP layer message exchanges takes place between user device and DHCP server located in the service provider network to assign IP address to the user device to enable IP level communication. This method takes this idea further by using IP level communication i.e. IP packets to carry user information to a remote server. This is accomplished by client software in user device which builds IP packet and sends it to remote server where these request are processed and responded.

Clients sends an IP packet with 8 bit protocol field in the IP header set to a value which is not commonly used (like TCP and UDP values). The destination address in the IP header is set to remote server IP address which is hosts the services and accessible through internet. The server will use IP packet similarly to reply for the requests received from the user. Since all the communication takes place at IP layer (not TCP or UDP) it doesn't require user id and password to go through.

This inventive method does not use conventional protocols like TCP/UDP for information delivery. Information is transmitted as payload on IP packets.

In one embodiment of the present technique, a method to bypass the existing pay and use model to deliver services/data over wireless local area network (WLAN) between mobile terminal and server is disclosed. The inventive method uses internet protocol (IP) packet for delivering services/data between server and mobile terminal. Internet protocol (IP) layer processes the IP packets received from a mobile terminal and uses protocol subfield in the IP header of the received IP packet in identifying the services/data at the server end. The server sends the IP packet containing requested services/data to the mobile terminal.

In one embodiment of the present technique, the access point (AP) will let through any communication that will help in the process of authenticating the user and access to internet if successful. To achieve this AP has to allow the following communication protocols before authentication (for all the user)

(1) Access to DHCP server for acquiring IP address
(2) Access to DNS server
(3) Allow any ICMP protocols to check the health of the communication link and the server to which it wants to communicate

The above protocol will help only in connection establishment, and will not be able to get any web page for which TCP connection is needed. The proposed method is to use the above mentioned protocols to send and get useful information for the user apart from its normal role as a facilitator in connection establishment.

The method uses the following protocols to get useful information for the user:

(1) ICMP (internet control message protocol) protocol
(2) DHCP (dynamic host configuration protocol) protocol
(3) DNS (domain name service) protocol

Since the protocols are used in a way that is different from its intended use, a server which can receive and understand such requests is a critical component of the overall system.

A server that can be reached by the mobile terminal via any AP will receive the requests generated in the above mentioned way and responds in a predetermined manner. The server will have methods to identify the packets that are coming from the mobile terminal that uses above mentioned mechanism for getting user information. The server response component will interpret the requests and respond to them appropriately. Since the mobile terminal needs to know the server that serves its requests a priori, there will be a fixed number of servers whose IP addresses are known to the mobile terminal.

Each protocol will contain data field that can be used to carry user query/response. For example ping packets (ICMP) contains data field whose length can be dynamically varied by the user, which can be used for carrying user information. Similarly server response can be inserted in the ping response packet data field which will be received and processed by the mobile terminal thus completing the bidirectional communication loop.

Thus in this way the existing pay and use model is bypassed and information/data/service will be delivered to user on his mobile terminal using this inventive method.

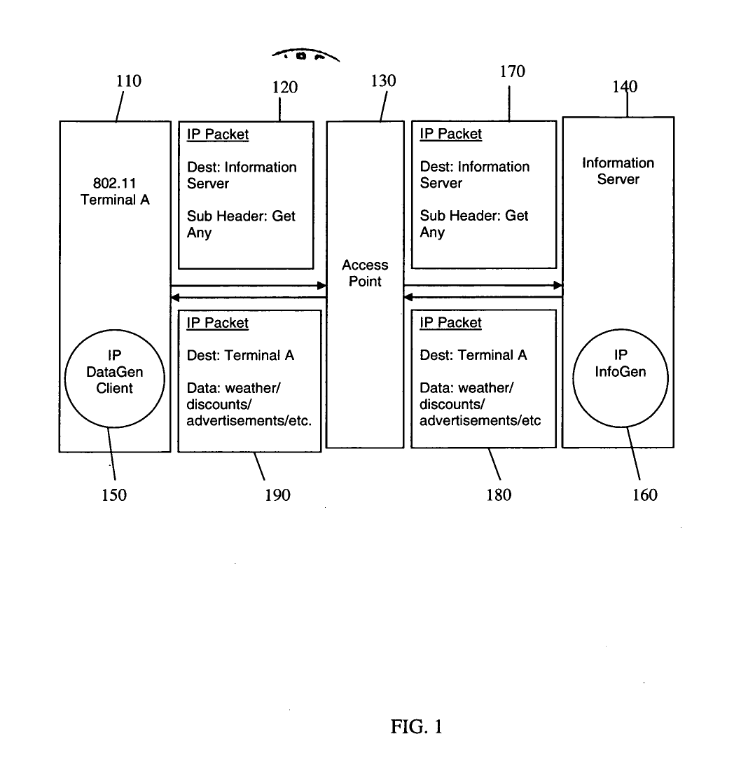

Referring to FIG. 1 which shows the hardware and software components to be required for the proposed method:

Hardware components:

1. 802.11-based wireless terminal 110

2. 802.11-based access point 130

3. Information server which consists of a CPU, memory, storage and network interface 140

4. DHCP server

### Software Components:

1. IP packet assimilator application on the wireless terminal—IP DataGen 150

2. IP packet assimilator application on the Information server—IP InfoGen 160

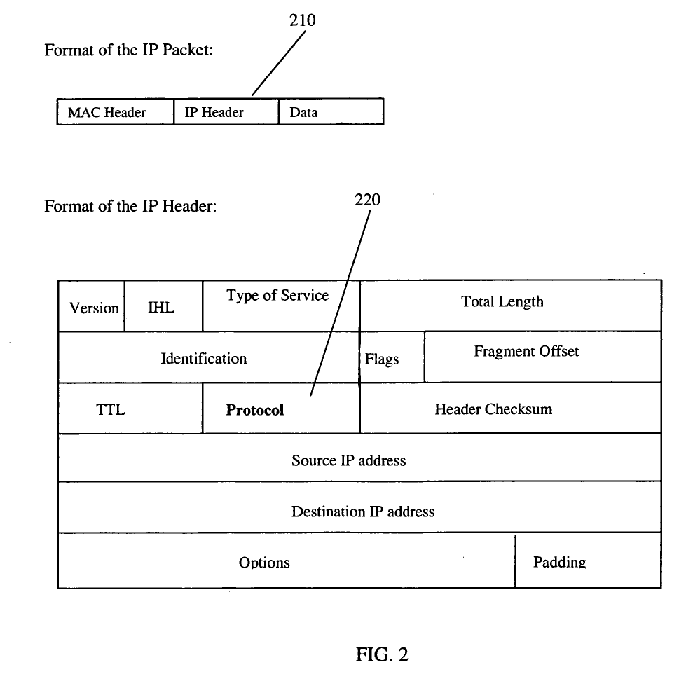

In another embodiment of the present technique, an 802.11 wireless terminal 110 runs an IP data generating client 150. The wireless terminal 110 connects to the Access Point 130 (associates). After successfully connecting to the Access Point 130, an IP address is allocated to the wireless terminal (mobile terminal) 110 by the access point 130 via the DHCP server. The IP DataGen client 150 (software application) on the 802.11 wireless terminal 110 sends a pre-defined IP packet 120 to the Information server 140 with a predefined next protocol requesting for all data. The format of the IP packet 120 will be as shown in FIG. 2 and described below. The access point 130 receives this IP packet 120 and forwards to the Information server 140. The Information server 140 receives the IP packet 170 and assimilates the request and responds by constructing a similar packet 180 in response using IP InfoGen software application 160. The method does not use conventional protocols like TCP/UDP for information delivery. Information is transmitted as payload on IP packets 190.

Referring to FIG. 2 which shows the format of the IP packet and format of the IP header 210 in IP packet. The Protocol field 220 in the IP header 210 is used to define the next protocol. The values 140-252 are not assigned to any next level protocol like TCP, UDP, DHCP, etc. These values can be used to request for specific data.

Thus the proposed method uses the IP packet for delivering data between the server and client without invoking TCP or UDP service. The method uses the protocol subfield in the IP header so that receiver (identified in destination address field of the packet) can use it as service identifier (equivalent to the role played by port number in TCP protocol). The pre-installed client/server software module (IP DataGen and IP InfoGen) constructs IP packet in the above mentioned way and interprets the response at receiver/transmitter end. Since all the communication takes place at IP layer (not TCP or UDP) it doesn't require user id and password to go through.

For example, suppose a client would like to get the news update over the available wireless network. The user's wireless terminal discovers the wireless network and associates itself and uses the DHCP service to obtain an IF address. The IP DataGen client on the user's wireless terminal would construct an IP packet with protocol field as 250 (not allocated) and sends to the Information server. The value 250 could be defined to send weather information only. The access point receives the packet and forwards the packet to the Information server. The Information server will then respond to the 802.11 based wireless terminal with an IP packet containing the requested data to the 802.11 based wireless terminal containing the weather information in its payload.

This invention opens new possibilities of delivering interne services over existing WLAN whether it is subscription based or not thus enhancing the reach of the services offered. For example the invention can be used to deliver advertisement to the user where revenue can be shared between WLAN network operator and advertiser.

Thus, the proposed method helps user by not having to subscribe to the multiple wireless LAN service providers to access useful services hosted in the interne. One of the novel applications of this method is delivering advertisement information using existing WLAN infrastructure.

### Exemplary Computing Environment

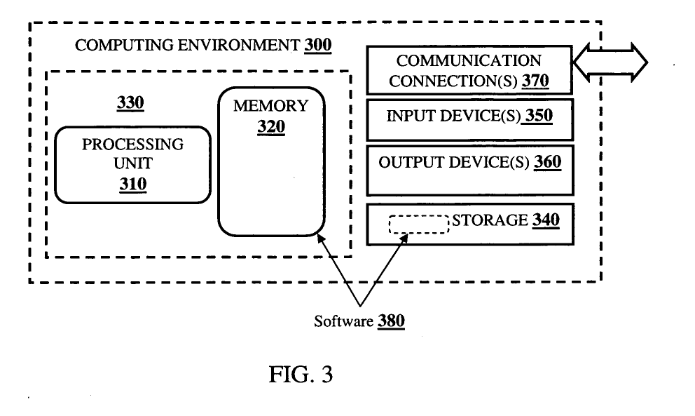

One or more of the above-described techniques may be implemented in or involve one or more computer systems. FIG. 3 illustrates a generalized example of a computing environment 300. The computing environment 300 is not intended to suggest any limitation as to scope of use or functionality of described embodiments.

With reference to FIG. 3, the computing environment 300 includes at least one processing unit 310 and memory 320. In FIG. 3, this most basic configuration 330 is included within a dashed line. The processing unit 310 executes computer-executable instructions and may be a real or a virtual processor. In a multi-processing system, multiple processing units execute computer-executable instructions to increase processing power. The memory 320 may be volatile memory (e.g., registers, cache, RAM), non-volatile memory (e.g., ROM, EEPROM, flash memory, etc.), or some combination of the two. In some embodiments, the memory 320 stores software 380 implementing described techniques.

A computing environment may have additional features. For example, the computing environment 300 includes storage 340; one or more input devices 350, one or more output devices 360, and one or more communication connections 370. An interconnection mechanism (not shown) such as a bus, controller, or network interconnects the components of the computing environment 300. Typically, operating system software (not shown) provides an operating environment for other software executing in the computing environment 300, and coordinates activities of the components of the computing environment 300.

The storage 340 may be removable or non-removable, and includes magnetic disks, magnetic tapes or cassettes, CD-ROMs, CD-RWs, DVDs, or any other medium which may be used to store information and which may be accessed within the computing environment 300. In some embodiments, the storage 340 stores instructions for the software 380.

The input device(s) 350 may be a touch input device such as a keyboard, mouse, pen, trackball, touch screen, or game controller, a voice input device, a scanning device, a digital camera, or another device that provides input to the computing environment 300. The output device(s) 360 may be a display, printer, speaker, or another device that provides output from the computing environment 300.

The communication connection(s) 370 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations may be described in the general context of computer-readable media. Computer-readable media are any available media that may be accessed within a computing environment. By way of example, and not limitation, within the computing environment 300, computer-readable media include memory 320, storage 340, communication media, and combinations of any of the above.

Having described and illustrated the principles of our invention with reference to described embodiments, it will be recognized that the described embodiments may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

In view of the many possible embodiments to which the principles of our invention may be applied, we claim as our invention all such embodiments as may come within the scope and spirit of the following claims and equivalents thereto.

While the present invention has been related in terms of the foregoing embodiments, those skilled in the art will recognize that the invention is not limited to the embodiments depicted. The present invention may be practiced with modification and alteration within the spirit and scope of the appended claims. Thus, the description is to be regarded as illustrative instead of restrictive on the present invention.

1. A method to bypass the existing pay and use model to deliver services/data over wireless local area network (LAN) between mobile terminal and server, the method comprising:
using internet protocol (IP) packet for delivering services/data between server and mobile terminal;
internet protocol (IP) layer for processing IP packets received from a mobile terminal;
using protocol subfield in the IP header of the IP packet in identifying the services/data at the server end; and
sending the IP packet containing requested services/data to the mobile terminal.

2. The method as recited in claim 1, further comprising allocating an IP address to the mobile terminal by the access point via the DHCP (dynamic host configuration protocol) server.

3. The method as recited in claim 1, further comprising IP packet assimilator application on the mobile terminal for constructing the IP packet with requested service.

4. The method as recited in claim 1, further comprising IP packet assimilator application on the server for constructing the IP packet with requested service.

5. The method as recited in claim 1, further comprising access point receiving the IP packet from the mobile terminal and forwarding to the server.

6. The method as recited in claim 1, wherein the mobile terminal comprises at least one of a mobile phone or a palm-top or lap-top or a personal digital assistant or a wireless terminal or mobile station or any mobile computing device or combinations thereof.

7. A computer program product comprising a computer usable medium having a computer readable program code embodied therein to bypass the existing pay and use model to deliver services/data over wireless LAN between mobile terminal and server, the method comprising:
program code adapted for using internet protocol (IP) packet for delivering services/data between server and mobile terminal;
program code adapted for internet protocol (IP) layer for processing IP packets received from a mobile terminal;
program code adapted for using protocol subfield in the IP header of the IP packet in identifying the services/data at the server end; and
program code adapted for sending the IP packet containing requested services/data to the mobile terminal.

8. The product of claim 1, further comprising program code adapted for allocating an IP address to the mobile terminal by the access point via the DHCP (dynamic host configuration protocol) server.

9. The product of claim 1, further comprising program code adapted for IP packet assimilator application on the mobile terminal for constructing the IP packet with requested service.

10. The product of claim 1, further comprising program code adapted for IP packet assimilator application on the server for constructing the IP packet with requested service.
